(19) United States
(12) Patent Application Publication
(10) Pub. No.: US 2025/0265272 A1
(43) Pub. Date: Aug. 21, 2025

(54) INFORMATION PROCESSING DEVICE, INFORMATION PROCESSING METHOD, AND NON-TRANSITORY COMPUTER READABLE STORAGE MEDIUM

(71) Applicant: LY Corporation, Tokyo (JP)

(72) Inventor: Takuro MORI, Tokyo (JP)

(21) Appl. No.: 19/048,663

(22) Filed: Feb. 7, 2025

(30) Foreign Application Priority Data
Feb. 19, 2024 (JP) 2024-022680

(51) Int. Cl. G06F 16/28; G06F 16/2455

(52) U.S. Cl. CPC G06F 16/285; G06F 16/2455

(57) ABSTRACT

An information processing device 100 includes: a specifying unit 132 that specifies search queries of a plurality of users who performs a predetermined action; a processing unit 133 that generates classification of the search queries and description content of each of a plurality of clusters by inputting, to a model having learned to output a character string following a character string input thereto, information regarding the search queries specified by the specifying unit 132 and a directive for clustering the search queries into the plurality of clusters in consideration of relevance among search queries and outputting description content describing each of the clusters on a basis of search queries classified into each of the clusters; and a provision unit 144 that provides information for displaying the plurality of clusters clustered by the model and the description content.

### CROSS-REFERENCE TO RELATED APPLICATIONS

The present application claims priority to and incorporates by reference the entire contents of Japanese Patent Application No. 2024-022680 filed in Japan on Feb. 19, 2024.

### BACKGROUND OF THE INVENTION

### 1. Field of the Invention

The present invention relates to an information processing device, an information processing method, and a non-transitory computer readable storage medium.

### 2. Description of the Related Art

In the related art, in query analysis devices, there is technology of generating an analysis graph that makes it possible to intuitively grasp a change in user's need with the lapse of time using queries input to a search site. As an example, there is known technology for generating an analysis graph that enables intuitive prehension by thinning out peripheral queries with respect to a main query serving as a reference.

### Patent Literature 1: Japanese Patent No. 6983269

However, in the related art, for example, there is room for further improvement for appropriately grasping a change in user's need.

### SUMMARY OF THE INVENTION

According to one aspect of an embodiment, it is possible to perform analysis for appropriately grasping a change in user's need.

### BRIEF DESCRIPTION OF THE DRAWINGS

FIG. 1 is a diagram illustrating a configuration example of an information processing system according to an embodiment;

FIG. 2 is a diagram illustrating an example of information processing according to an embodiment;

FIG. 3 is a diagram illustrating an example of a prompt according to the embodiment;

FIG. 4 is a diagram illustrating an example of a clustering result according to the embodiment;

FIG. 5 is a diagram illustrating a configuration example of a terminal device according to the embodiment;

FIG. 6 is a diagram illustrating a configuration example of an information processing device according to the embodiment;

FIG. 7 is a table showing an example of a search action storing unit according to the embodiment;

FIG. 8 is a flowchart illustrating an example of information processing according to the embodiment; and

FIG. 9 is a hardware configuration diagram illustrating an example of a computer that implements functions of the information processing device.

### DETAILED DESCRIPTION OF THE PREFERRED EMBODIMENTS

Hereinafter, modes for carrying out the present invention (hereinafter referred to as embodiments) will be described with reference to the drawings. Note that the present invention is not limited by the embodiments described below. Furthermore, in the description of the drawings, the same portions are denoted by the same reference numerals.

### Embodiments

### 1. Configuration of Information Processing System

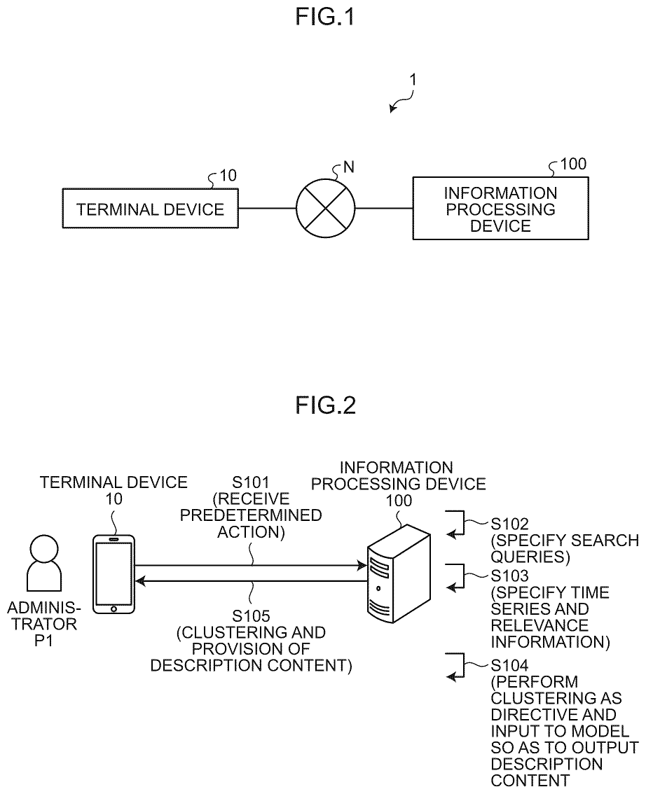

An information processing system 1 illustrated in FIG. 1 will be described. As illustrated in FIG. 1, the information processing system 1 includes a terminal device 10 and an information processing device 100. The terminal device 10 and the information processing device 100 are communicably connected in a wired or wireless manner via a predetermined communication network (network N). FIG. 1 is a diagram illustrating a configuration example of the information processing system 1 according to an embodiment.

The terminal device 10 is an information processing device used by an administrator who performs customer journey analysis and the like of users for marketing. The administrator appropriately grasps a change in user's need by performing, for example, a customer journey analysis. The terminal device 10 may be any device as long as the processing in the embodiment can be implemented. Furthermore, the terminal device 10 may be a device such as a smartphone, a tablet terminal, a lap-top PC, a desktop PC, a mobile phone, or a PDA. FIG. 2 illustrates a case where the terminal device 10 is a smartphone.

The terminal device 10 is, for example, a smart device such as a smartphone or a tablet and is a portable terminal device capable of communicating with any server device via a wireless communication network such as the 4th generation (4G) to 5G or Long Term Evolution (LTE). Furthermore, the terminal device 10 may have a screen such as a liquid crystal display and having a touch panel function and may receive various operations on display data such as content, such as a tap operation, a slide operation, and a scroll operation, from an administrator with a finger, a stylus, or the like. In FIG. 2, the terminal device 10 is used by an administrator P1.

The information processing device 100 is for the purpose of performing analysis for appropriately grasping changes in the user's need and may be any device as long as the processing in the embodiment can be implemented. The information processing device 100 inputs, to a model having learned to output a character string following a character string input thereto, for example, information regarding search queries and a directive for clustering the search queries into a plurality of clusters in consideration of relevance among search queries and outputting description content describing each of the clusters on the basis of search queries classified into each of the clusters, thereby generating classification of the search queries and description content of each of the clusters to visualize the classification result on a graph. At this point, for example, the information processing device 100 performs visualization by determining a date and time when a predetermined action, which is a starting point of the time series, has been performed (such as input of a reference query or input of a reference action), specifying time-series information indicating the time series of searches in which preceding and subsequent search queries have been used and relevance information indicating relevance among search queries, and inputting, as the directive, the directive for clustering in consideration of the time series indicated by the time-series information and the relevance indicated by the relevance information to the model that has been learned in such a manner as to output a character string following a character string input thereto. In this manner, the information processing device 100 performs clustering of the search queries by, for example, determining the predetermined action and using the time series of the preceding and subsequent search queries. The information processing device 100, for example, provides services such as behavior analysis for customer journey analysis. Note that, in the following embodiment, when the predetermined action is specified, the information processing device 100 performs processing using the specified predetermined action as the reference action. At this point, the predetermined action may be specified in any manner and, for example, may be specified by the administrator or the like. Alternatively, the predetermined action may be determined in advance by the administrator or the like of the information processing device 100 or may be automatically set by the information processing device 100 on the basis of a predetermined rule. In FIG. 2, a case where the predetermined action is specified by the administrator P1 is described as an example.

Note that, although FIG. 1 illustrates a case where the terminal device 10 and the information processing device 100 are separate devices, the terminal device 10 and the information processing device 100 may be integrated.

### 2. Example of Information Processing

FIG. 2 is a diagram illustrating an example of information processing by the information processing system 1 according to the first embodiment. For example, when the administrator P1 specifies a predetermined action, the information processing device 100 receives the designation of the predetermined action (step S101). For example, the information processing device 100 accepts designation of a search query, an accommodation reservation date, and others as the predetermined action. When the specified predetermined action is set as the reference action, the information processing device 100 specifies search queries used for another search by a plurality of users who has performed the reference action (step S102). For example, in a case where “accommodation reservation date” is the reference action, the information processing device 100 specifies other search queries of a plurality of users who has performed the reference action of “accommodation reservation”. For example, in a case where a user U1 has performed a search for “poles”, “ski wear”, or the like before or after the reference action of “accommodation reservation” and a user U2 has performed a search for “leash cord”, “long board”, or the like before or after the reference action of “accommodation reservation”, the information processing device 100 specifies search queries such as “poles”, “ski wear”, “leash cord”, and “long board”. Note that, in step S102, the information processing device 100 may specify search queries only for a plurality of users who has performed a search that satisfies a predetermined condition regarding the reference action. For example, the information processing device 100 may specify search queries by narrowing the reference action down to a plurality of users who has input the reference action within a predetermined period or may specify search queries by narrowing the reference action to a plurality of users who has input the reference action a predetermined number of times or more. Furthermore, the information processing device 100 may specify a search query satisfying a predetermined condition among the search queries specified in step S101 and perform processing described later.

Furthermore, the information processing device 100 specifies time-series information indicating time series from the search dates and time when the search queries have been used for a search, with the date and time, when the predetermined action has been performed (which may be the search date and time), used as reference date and time (t=0) (step S103). At this point, the information processing device 100 specifies relative search dates and time of the search queries with respect to the reference date and time. For example, in a case where a search for “ski wear” has been performed one day prior to the day of inputting “accommodation reservation”, the information processing device 100 specifies a relative search date and time such as “ski wear; t=−1” based on t=0. In this manner, the information processing device 100 specifies search dates and time of all the search queries specified in step S102. The information processing device 100 may further perform processing described later only on a search query in which a time difference between the date and time when the predetermined action has been performed and a search date and time of the search query satisfies a predetermined condition.

Moreover, in step S103, the information processing device 100 specifies relevance information indicating relevance among the search queries specified in step S102 in addition to the time-series information (step S103). For example, the information processing device 100 specifies search queries having a deep relationship with the same purpose of action for each of the search queries, as the same purpose of action or seasonal relevance. Specifically, when the purpose of action is set to “skiing”, the information processing device 100 specifies “ski wear” and “poles” related to this purpose of action (for example, supplies for skiing) as those having relevance. The information processing device 100 may further perform processing described later only on a search query in which a relevance between the action of performing the predetermined action and a search for the search query satisfies a predetermined condition.

Then, the information processing device 100 inputs, to a model having learned to output a character string following a character string input thereto, information regarding search queries specified by the specifying unit in step S103 and a directive for clustering the search queries into a plurality of clusters in consideration of relevance among search queries and outputting description content describing each of the clusters on the basis of search queries classified into each of the clusters, thereby generating classification of the search queries and description content of each of the clusters (step S104). For example, the information processing device 100 may use, as the model, generative AI such as a generative pre-trained transformer (GPT) model. Note that the time-series information may be taken into consideration in the directive in some cases.

Furthermore, in a case where a directive to consider the time-series information is generated, the information processing device 100 inputs, to the model, as the directive, the directive instructing to perform clustering in consideration of the time series indicated by the time-series information and the relevance indicated by the relevance information. Furthermore, the information processing device 100 inputs, to the model, a directive instructing to output description content describing each of the clusters on the basis of search queries classified into the cluster. For example, the information processing device 100 generates the classification of the search queries in consideration of the time series and the relevance by taking the time-series information and the relevance information into consideration. Furthermore, the information processing device 100 generates the description content on the basis of the classification of the search queries. For example, the information processing device 100 generates the classification of the search queries and the description content for the purpose of classifying and displaying, on a graph in time series, searches using search queries classified into “ski equipment”, “marine sports”, or the like are performed at which timing before and after the reference action of “accommodation reservation”. Note that there may be a case where the classification of the search queries is generated without generating the description content.

Furthermore, the information processing device 100 inputs, to the model, as the directive, the directive instructing to perform clustering such that a cluster includes search queries belonging to the same purpose of action on the basis of relevance among the search queries indicated by the relevance information. For example, when the purpose of action is set to “skiing”, the information processing device 100 generates classification of the search queries by setting “ski wear” and “poles” related to this purpose of action (for example, supplies for skiing) as those having relevance.

The information processing device 100 further inputs, to the model, as the directive, the directive instructing to perform clustering in consideration of relevance indicated by the relevance information and to perform clustering in consideration of relevance among the clusters that have been classified. For example, in a case where the clusters are “ski equipment”, “snowboard equipment”, “marine sports”, and “surfing equipment”, the information processing device 100 generates classification of the search queries in such a manner that “ski equipment” and “snowboard equipment” are arranged close to each other when displayed in the graph in consideration of relevance to winter sports. In addition, “marine sports” and “surfing equipment” have relevance to summer sports, and the information processing device 100 generates classification of the search queries in such a manner that they are arranged close to each other when displayed in the graph in consideration of the relevance.

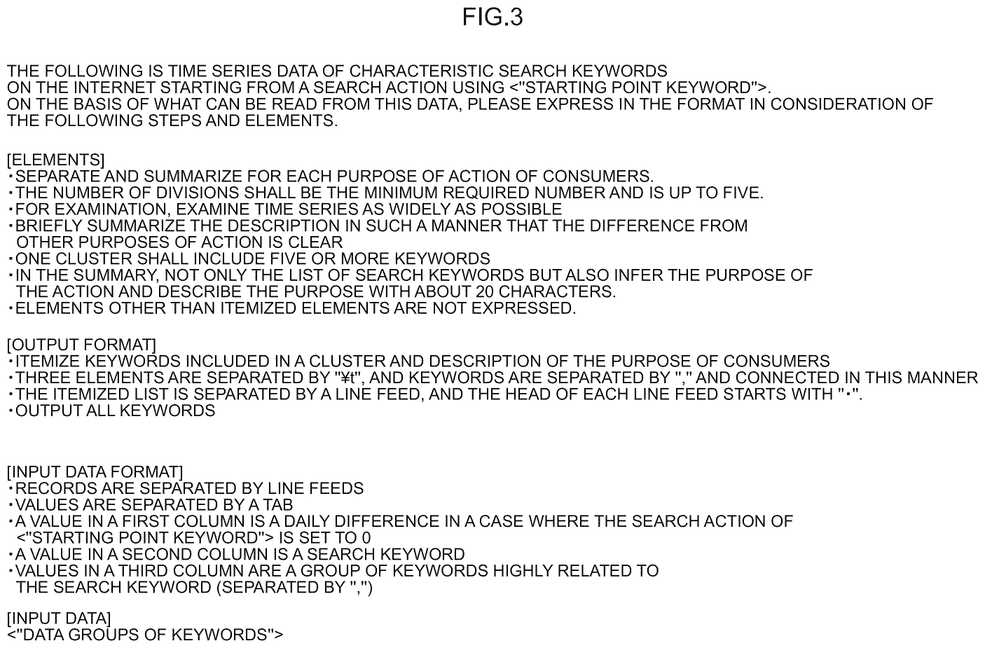

FIG. 3 is a diagram illustrating an example of a prompt according to the embodiment. The information processing device 100 inputs, to the learned model, as a prompt, a directive of “The following is time series data of characteristic search keywords on the Internet starting from a search action using <“starting point keyword”>. On the basis of what can be read from this data, please express in the format in consideration of the following steps and elements.”, “Elements” specifying elements, “Output Format” specifying the format of output result, “Input Data Format” specifying the format of input information, and “input data” specifying the input information. The learned model outputs clusters clustered on the basis of these pieces of information.

As the directive, the directive is input to the model, the directive instructing to perform clustering in consideration of the time series indicated by the time-series information of a period specified by the user and a specified predetermined period and relevance indicated by the relevance information and, in a case where the description content in the period specified by the user and the description content in the specified predetermined period are different from each other in the period specified by the user, instructing to perform at least one of output of an alert or correction. For example, in a case where the period specified by the user is ten months, the information processing device 100 sets the specified predetermined period to a longer period, for example, fourteen months. In this case, in a case where description content for the period specified by the user (ten months) of description content generated from the specified predetermined period (fourteen months) is different from description content generated from the period specified by the user (ten months), at least one of output of an alert or correction is performed.

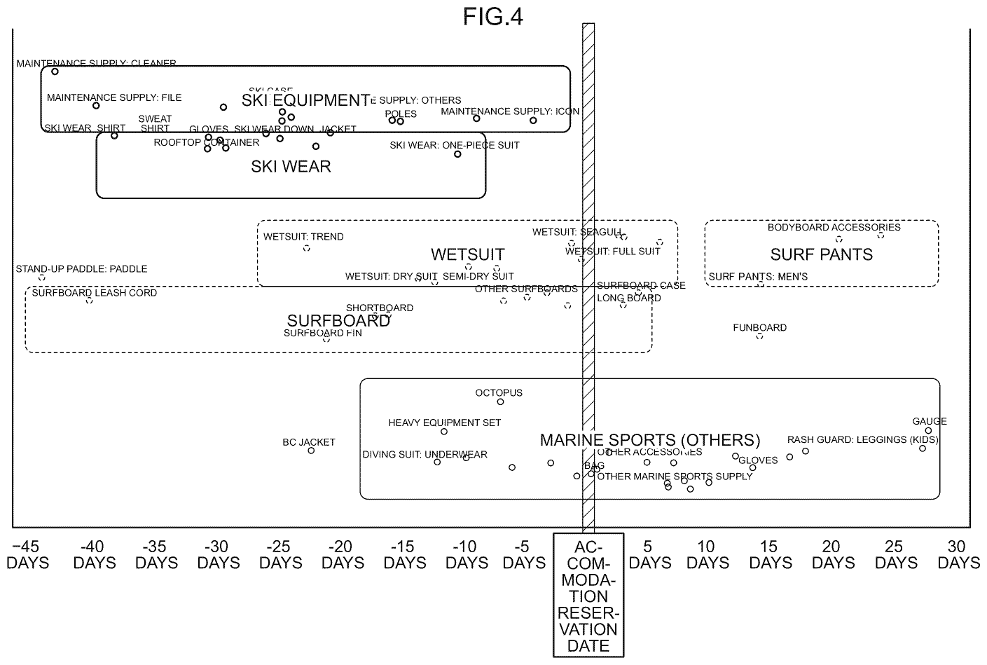

Then, the information processing device 100 provides information for displaying the plurality of clusters clustered by the model and the description content. For example, the information processing device 100 transmits the description content of the plurality of clusters to the terminal device 10 (step S105). Upon receiving the information transmitted from the information processing device 100, the terminal device 10 displays the clustering result and the description content on the basis of the received information. Furthermore, the information processing device 100 transmits information for displaying the description content superimposed on the clustering result. For example, the information processing device 100 transmits information for superimposing and displaying each piece of description content generated for one of the clusters in association with the cluster. In the terminal device 10, the description content is displayed superimposed on the clustering result. FIG. 4 is a diagram illustrating an example of a clustering result according to the embodiment. With reference to FIG. 4, a case where six clusters are classified will be described as an example. In FIG. 4, the horizontal axis represents the time series. In addition, a search date and time of a search query with respect to the reference date and time is reflected in the time series of the horizontal axis. In addition, since the information processing device 100 has generated the description content of “ski equipment”, generated the description content of “ski wear”, generated the description content of “wetsuit”, generated the description content of “surf pants”, generated the description content of “surfboard”, and generated the description content of “marine sports (others)”, “ski equipment” is displayed as the description content, “ski wear” is displayed as the description content, “wetsuit” is displayed as the description content, “surf pants” is displayed as the description content, “surfboard” is displayed as the description content, and “marine sports (others)” is displayed as the description content. Note that the clustering result illustrated in FIG. 4 is one example, and the number of regions classified into clusters or others may not be particularly limited.

In this manner, the information processing device 100 inputs, to the model having learned to output a character string following the character string input thereto, the directive for clustering the search queries into the plurality of clusters in consideration of relevance among search queries and the time series and outputting the description content describing each of the clusters on the basis of search queries classified into each of the clusters, thereby visualizing the classification of the search queries and the description content of each of the clusters on the graph generated It is conceivable that visualization of the search queries in time series makes it possible to use the search queries for review of customer journey analysis and the like.

### 3. Configuration of Terminal Device

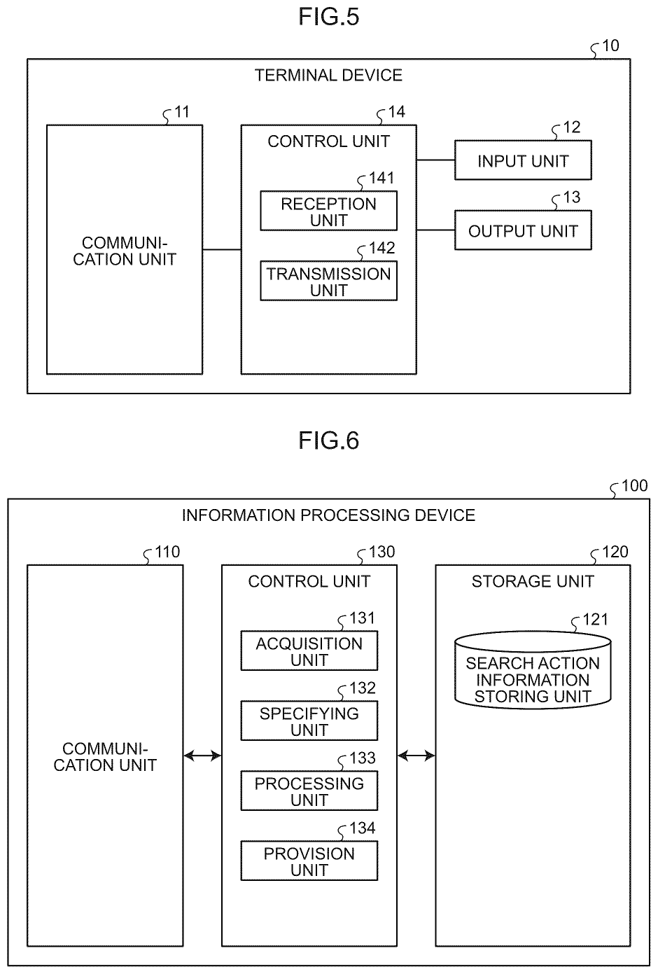

Next, the configuration of the terminal device 10 according to the embodiment will be described with reference to FIG. 5. FIG. 5 is a diagram illustrating a configuration example of the terminal device 10 according to the embodiment. As illustrated in FIG. 5, the terminal device 10 includes a communication unit 11, an input unit 12, an output unit 13, and a control unit 14.

### (Communication Unit 11)

The communication unit 11 is implemented by, for example, a network interface card (NIC) or the like. The communication unit 11 is connected to a predetermined network N in a wired or wireless manner and transmits and acquires information to and from the information processing device 100 and others via the predetermined network N.

### (Input Unit 12)

The input unit 12 receives various operations from the administrator. In FIG. 2, various operations from the administrator P1 are received. For example, the input unit 12 may receive various operations from the administrator via a display plane by a touch panel function. Furthermore, the input unit 12 may receive various operations from a button provided to the terminal device 10 or a keyboard or a mouse connected to the terminal device 10. For example, the input unit 12 receives an operation for specifying a predetermined action.

### (Output Unit 13)

The output unit 13 is a display screen of a tablet terminal or the like that is implemented by, for example, a liquid crystal display, an organic electro-luminescence (EL) display, or the like and is a display device for displaying various types of information. For example, the output unit 13 displays information transmitted from the information processing device 100. For example, the output unit 13 displays a plurality of clusters clustered by the model and description content that are transmitted from the information processing device 100.

### (Control Unit 14)

The control unit 14 is, for example, a controller and is implemented by executing various programs stored in a storage device inside the terminal device 10 using a random access memory (RAM) as a work area by a central processing unit (CPU), a micro processing unit (MPU), or the like. For example, the various programs include a program of an application installed in the terminal device 10. For example, the various programs include an application program for displaying the information transmitted from the information processing device 100 (phase classification result, description content, and the like). Furthermore, the control unit 14 is implemented by, for example, an integrated circuit such as an application specific integrated circuit (ASIC) or a field programmable gate array (FPGA).

As illustrated in FIG. 5, the control unit 14 includes a reception unit 141 and a transmission unit 142 and implements or executes the action of information processing described below.

### (Reception Unit 141)

The reception unit 141 receives, for example, information transmitted from the information processing device 100. For example, the reception unit 141 receives information for displaying the classification result of the search queries and the description content output by the model, which have been transmitted from the information processing device 100. For example, the reception unit 141 receives information for displaying the classification result of the search queries together with the description content. For example, the reception unit 141 receives information for superimposing and displaying the description content on the classification result of the search queries.

### (Transmission Unit 142)

The transmission unit 142 transmits, for example, operation information performed by the administrator. For example, the transmission unit 142 transmits information related to the predetermined action specified by the administrator (such as information indicating a predetermined query or an accommodation reservation date) in order to determine the predetermined action.

### 4. Configuration of Information Processing Device

Next, the configuration of the information processing device 100 according to the embodiment will be described with reference to FIG. 6. FIG. 6 is a diagram illustrating a configuration example of the information processing device 100 according to the embodiment. As illustrated in FIG. 6, the information processing device 100 includes a communication unit 110, a storage unit 120, and a control unit 130. Note that the information processing device 100 may include an input unit (such as a keyboard and a mouse) that receives various operations from the administrator of the information processing device 100 and a display unit (such as a liquid crystal display) that displays various types of information.

### (Communication Unit 110)

The communication unit 110 is implemented by, for example, an NIC or the like. The communication unit 110 is connected with the network N in a wired or wireless manner and transmits and acquires information to and from the terminal device 10 and the like via the network N.

### (Storage Unit 120)

The storage unit 120 is implemented by, for example, a semiconductor memory element such as a RAM or a flash memory or a storage device such as a hard disk or an optical disk. As illustrated in FIG. 6, the storage unit 120 includes a search action information storing unit 121.

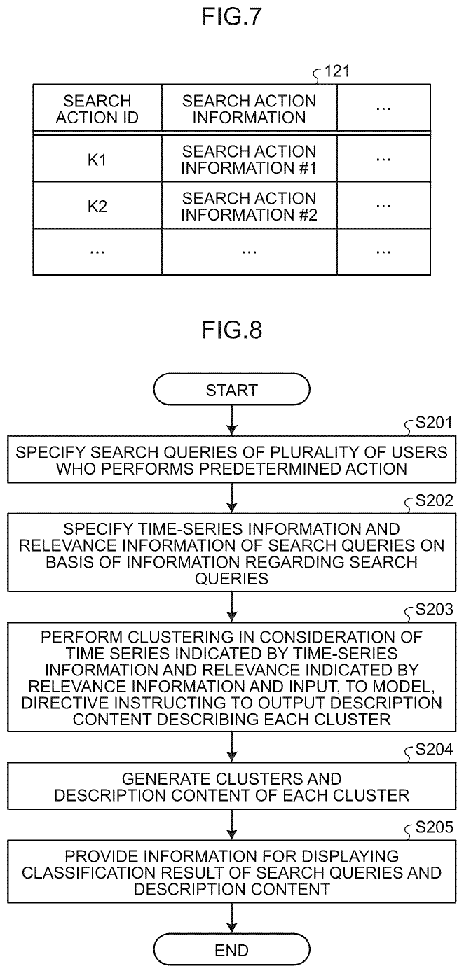

The search action information storing unit 121 stores information regarding the search action of the user. Illustrated in FIG. 7 is an example of the search action information storing unit 121 according to the embodiment. The information stored in the search action information storing unit 121 is used, for example, to generate the classification result of the search queries and the description content. As illustrated in FIG. 7, the search action information storing unit 121 includes items such as “search action ID” and “search action information”.

The “search action ID” indicates identification information for identifying a search action. The “search action information” indicates search action information. In the example illustrated in FIG. 7, although an example in which conceptual information such as “Search Action Information #1” and “Search Action Information #2” is stored in “Search Action Information” has been described, actually stored is information indicating which user has searched with what search query and when.

### (Control Unit 130)

The control unit 130 is a controller and is implemented by, for example, a CPU, an MPU, or the like executing various programs stored in a storage device inside the information processing device 100 using a RAM as a work area. Furthermore, the control unit 130 is implemented by, for example, an integrated circuit such as an ASIC or an FPGA.

As illustrated in FIG. 6, the control unit 130 includes an acquisition unit 131, a specifying unit 132, a processing unit 133, and a provision unit 134 and implements or executes the action of information processing described below. Note that the internal configuration of the control unit 130 is not limited to the configuration illustrated in FIG. 6 and may be another configuration as long as the information processing to be described later is performed.

### (Acquisition Unit 131)

The acquisition unit 131 acquires various types of information from the storage unit 120. The acquisition unit 131 further stores the acquired various types of information in the storage unit 120.

The acquisition unit 131 acquires various types of information from an external information processing device 100. The acquisition unit 131 acquires various types of information from another information processing device 100 such as the terminal device 10.

The acquisition unit 131 acquires, for example, operation information performed by the administrator. For example, the acquisition unit 131 acquires information regarding the predetermined action specified by the administrator (such as information indicating a predetermined query) to determine the reference action.

### (Specifying Unit 132)

The specifying unit 132 specifies search queries of a plurality of users who performs a predetermined action. For example, the specifying unit 132 specifies a search query, an accommodation reservation date, or others as the predetermined action. For example, the specifying unit 132 specifies search queries of a plurality of users who has performed the predetermined action on the basis of the information acquired by the acquisition unit 131. In other words, for example, the specifying unit 132 specifies other search queries input for searches by a plurality of users who has input for performing the predetermined action on the basis of the predetermined action.

The specifying unit 132 specifies the time-series information indicating the time series of searches in which the search queries have been used, with the date and time when the predetermined action has been performed used as the reference date and time, and the relevance information indicating relevance among the search queries. For example, on the basis of the information acquired by the acquisition unit 131, the specifying unit 132 specifies the search date and time when the search query has been used for a search, with the date and time when the predetermined action has been performed used as the reference date and time. For example, the specifying unit 132 specifies a relative search date and time of the search query with respect to the reference date and time. For example, the specifying unit 132 specifies time-series information from the relative search date and time of the search query with respect to the specified reference date and time. Note that the specifying unit 132 may specify only the relevance information without specifying the time-series information.

### (Processing Unit 133)

The processing unit 133 inputs, to the model having learned to output a character string following a character string input thereto, information regarding search queries specified by the specifying unit 132 and a directive for clustering the search queries into a plurality of clusters in consideration of relevance among search queries and outputting description content describing each of the clusters on the basis of search queries classified into each of the clusters, thereby generating classification of the search queries and description content of each of the clusters. For example, the processing unit 133 inputs a directive considering relevance for each search query to the model, thereby generating one cluster with a search query related to ski equipment such as “skis” and “poles”, and generating a description of the ski equipment as description content describing the cluster. For example, the processing unit 133 may use, as the model, generative AI such as a generative pre-trained transformer (GPT) model.

Furthermore, the processing unit 133 inputs, to the model, as the directive, a directive instructing to perform clustering in consideration of time series indicated by the time-series information and relevance indicated by the relevance information. For example, the processing unit 133 inputs a directive in consideration of the relevance for each search query and the time-series information to the model, thereby generating the classification of the search queries including the time series of the clusters with respect to the reference date and time when the predetermined action has been performed, in addition to the clustering performed in consideration of the relevance.

The processing unit 133 inputs, to the model, as the directive, the directive instructing to perform clustering such that a cluster includes search queries belonging to the same purpose of action on the basis of relevance among the search queries indicated by the relevance information. For example, the processing unit 133 inputs, to the model, a directive to take into consideration the relevance among search queries (such as “poles”, “skis”, and “surfboard”), thereby performing clustering with such a consideration that “poles” and “skis” having the same purpose of action of skiing are included in the same cluster, thereby generating classification of the search queries.

The processing unit 133 inputs, to the model, as the directive, the directive instructing to perform clustering in consideration of relevance indicated by the relevance information and to perform clustering in consideration of relevance among the clusters that have been classified. For example, in a case where the clusters are “ski equipment”, “snowboard equipment”, “marine sports”, and “surfing equipment”, the clusters of “ski equipment” and “snowboard equipment” have relevance to winter sports, and thus the processing unit 133 generates the classification of the search queries such that they are arranged close to each other when displayed in the graph in consideration of the relevance. In addition, for example, “marine sports” and “surfing equipment” have relevance to summer sports, and the information processing device 100 generates classification of the search queries in such a manner that they are arranged close to each other when displayed in the graph in consideration of the relevance.

The processing unit 133 further inputs, to the model, as the directive, the directive instructing to output description content describing each of the clusters on the basis of search queries classified to the cluster. The processing unit 133 performs clustering in consideration of the relevance information and the time-series information and generates the description content describing each of the clusters on the basis of search queries classified to the cluster. For example, the processing unit 133 generates the description content in which both the relevance information and the time-series information are taken into consideration by taking the time series indicated by the time-series information into consideration in addition to the relevance indicated by the relevance information. Furthermore, the processing unit 133 generates the description content describing each of the clusters on the basis of search queries classified to each of the clusters within a range specified by the user by taking the time-series information into consideration.

The processing unit 133 inputs, to the model, as the directive, a directive instructing to perform clustering in consideration of the time series indicated by the time-series information of the period specified by the user and the predetermined period specified by the specifying unit 132 and relevance indicated by the relevance information and, in a case where the description content in the period specified by the user and the description content in the predetermined period specified by the specifying unit 132 are different from each other in the period specified by the user, instructing to perform at least one of output of an alert or correction. For example, in a case where the period specified by the user is eight months, in a case where description content generated on the basis of search queries in eight months before and after the reference date and time when the predetermined action has been performed is different from description content for eight months of description content generated on the basis of search queries specified in a period longer than the period specified by the user (for example, ten months), the processing unit 133 outputs an alert indicating that the pieces of description content are different. Furthermore, in a case where the description content is different, the processing unit 133 corrects the description content to description content generated on the basis of search queries specified in a period longer than the period specified by the user. Note that an alert indicating that the description content is different or an alert indicating that the correction has been performed may be output simultaneously with the correction.

### (Provision Unit 134)

The provision unit 134 provides information for displaying a plurality of clusters classified by the model and the description content. For example, the provision unit 134 provides the plurality of clusters generated by the processing unit 133 and the description content to the administrator who has specified the predetermined action.

Furthermore, the provision unit 134 provides information for displaying the description content to be superimposed on the clustering result. For example, the provision unit 134 provides information for superimposing and displaying each piece of the description contents generated for one of the clusters in association with the cluster. For example, in the terminal device 10, the description content is displayed superimposed on the clustering result.

### 5. Flow of Information Processing

Next, a procedure of information processing by the information processing system 1 according to the embodiment will be described with reference to FIG. 8. FIG. 8 is a flowchart illustrating the procedure of information processing by the information processing system 1 according to the embodiment.

As illustrated in FIG. 8, the information processing device 100 specifies search queries of a plurality of users who has performed a predetermined action (step S201).

The information processing device 100 specifies time-series information and the relevance information of the search queries on the basis of the information regarding the specified search query (step S202).

The information processing device 100 performs clustering in consideration of the time series indicated by the time-series information and relevance indicated by the relevance information and inputs, to the model, a directive instructing to output the description content describing each of the clusters (step S203).

Furthermore, the information processing device 100 generates clusters and description content by inputting the directive to the model (step S204).

The information processing device 100 provides information for displaying the classification result of the search queries and the description content (step S205).

### 6. Effects

As described above, the information processing device 100 according to the embodiment includes: the specifying unit 132 that specifies search queries of a plurality of users who performs a predetermined action; the processing unit 133 that inputs, to a model having learned to output a character string following a character string input thereto, information regarding the search queries specified by the specifying unit 132 and a directive for clustering the search queries into a plurality of clusters in consideration of relevance among search queries and outputting description content describing each of the clusters on the basis of search queries classified into each of the clusters to generate classification of the search queries and description content of each of the clusters; and the provision unit 134 that provides information for displaying the plurality of clusters clustered by the model and the description content.

As a result, the information processing device 100 according to the embodiment can, for example, display the description content together with the classification result of the search queries and thus can appropriately visualize the classification result of the search queries. Furthermore, the information processing device 100 according to the embodiment can perform analysis for appropriately grasping changes in the user's need by, for example, classifying the search queries in consideration of relevance among search queries.

In addition, the specifying unit 132 specifies the time-series information indicating time series of searches in which the search queries have been used and relevance information indicating relevance of the search queries, with a date and time when the predetermined action has been performed used as the reference date and time, and the processing unit 133 inputs, to the model, as the directive, the directive instructing to perform clustering in consideration of time series indicated by the time-series information and relevance indicated by the relevance information.

As a result, the information processing device 100 according to the embodiment can perform analysis for appropriately grasping changes in the user's need by, for example, generating the plurality of clusters and the description content in time series.

The specifying unit 132 specifies the relevance information indicating relevance among the search queries, and the processing unit 133 inputs, to the model, as the directive, the directive instructing to perform clustering such that a cluster includes search queries belonging to the same purpose of action on the basis of relevance among the search queries indicated by the relevance information.

As a result, the information processing device 100 according to the embodiment can perform analysis for appropriately grasping changes in the user's need by, for example, classifying into clusters each including search queries belonging to the same purpose of action and visualizing the clusters on the graph.

Furthermore, the specifying unit 132 specifies the relevance information indicating relevance among the search queries, and the processing unit 133 inputs, to the model, as the directive, the directive instructing to perform clustering in consideration of relevance indicated by the relevance information and to perform clustering in consideration of relevance among the clusters that have been classified.

As a result, the information processing device 100 according to the embodiment can perform analysis for appropriately grasping changes in the user's need since, for example, clustering is performed in consideration of the relevance of the clusters, and thus clusters having relevance to each other are collectively displayed when displayed in the graph.

The processing unit 133 further inputs, to the model, as the directive, the directive instructing to output description content describing each of the clusters on the basis of search queries classified to the cluster.

As a result, the information processing device 100 according to the embodiment can perform analysis for appropriately grasping changes in the user's need since, for example, the description content can be displayed for each of the clusters.

In addition, as the directive, the directive is input to the model, the directive instructing to perform clustering in consideration of the time series indicated by the time-series information of the period specified by the user and the predetermined period specified by the specifying unit 132 and relevance indicated by the relevance information and, in a case where the description content in the period specified by the user and the description content in the predetermined period specified by the specifying unit 132 are different from each other in the period specified by the user, instructing to perform at least one of output of an alert or correction.

As a result, the information processing device 100 according to the embodiment can perform analysis for appropriately grasping changes in the user's need even in a case where the user cannot specify an appropriate period since, for example, the alert is output or correction is made in a case where the description content is different between the period specified by the user and the predetermined period specified by the specifying unit 132.

### 7. Hardware Configuration

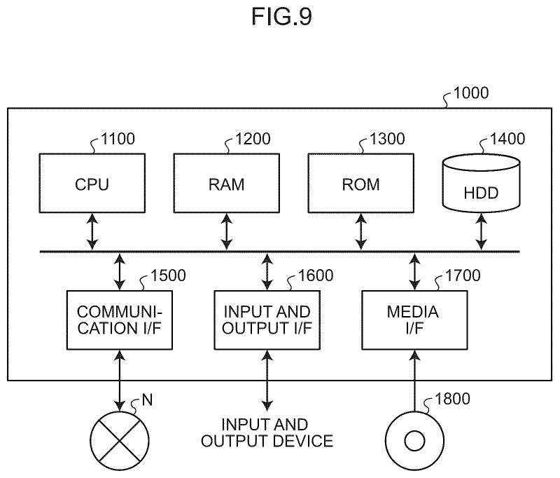

Furthermore, the information processing device 100 according to the above-described embodiment is implemented by, for example, a computer 1000 having a configuration as illustrated in FIG. 9. FIG. 9 is a hardware configuration diagram illustrating an example of a computer that implements functions of the information processing device 100. The computer 1000 includes a CPU 1100, a RAM 1200, a ROM 1300, an HDD 1400, a communication interface (I/F) 1500, an input and output interface (I/F) 1600, and a media interface (I/F) 1700.

The CPU 1100 operates on the basis of a program stored in the ROM 1300 or the HDD 1400 and controls each unit. The ROM 1300 stores a boot program executed by the CPU 1100 when the computer 1000 is activated, a program dependent on the hardware of the computer 1000, and others.

The HDD 1400 stores a program executed by the CPU 1100, data used by the program, and others. The communication interface 1500 acquires data from another device via a predetermined communication network, sends the data to the CPU 1100, and transmits data generated by the CPU 1100 to another device via a predetermined communication network.

The CPU 1100 controls output devices such as a display and a printer and input devices such as a keyboard and a mouse via the input and output interface 1600. The CPU 1100 acquires data from an input device via the input and output interface 1600. In addition, the CPU1100 outputs generated data to an output device via the input and output interface 1600.

The media interface 1700 reads a program or data stored in a recording medium 1800 and provides the program or data to the CPU 1100 via the RAM 1200. The CPU1100 loads the program from the recording medium 1800 onto the RAM 1200 via the media interface 1700 and executes the loaded program. The recording medium 1800 is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, or the like.

For example, in a case where the computer 1000 functions as the information processing device 100 according to the embodiment, the CPU 1100 of the computer 1000 implements the function of the control unit 130 by executing a program loaded on the RAM 1200. The CPU 1100 of the computer 1000 reads and executes these programs from the recording medium 1800; however, as another example, these programs may be acquired from another device via a predetermined communication network.

### 8. Others

Among the processing described in the above embodiments, the whole or a part of the processing described as being performed automatically can be performed manually, or the whole or a part of the processing described as being performed manually can be performed automatically by a known method. In addition, the processing procedure, specific names, and information including various types of data and parameters described herein or illustrated in the drawings can be modified as desired unless otherwise specified. For example, the various types of information illustrated in the drawings are not limited to the illustrated information.

In addition, each component of each device illustrated in the drawings is functionally conceptual and is not necessarily physically configured as illustrated in the drawings. That is, a specific form of distribution and integration of each device is not limited to the illustrated form, and all or a part thereof can be functionally or physically distributed and integrated in any unit depending on various loads, use conditions, and others.

In addition, the above-described embodiments can be combined as appropriate within a range in which the processing contents do not contradict each other.

Although some of the embodiments of the present application have been described in detail with reference to the drawings, these are merely examples, and the present invention can be implemented in other forms in which various modifications or improvements are made on the basis of the knowledge of those skilled in the art in addition to the modes described in the disclosure of the invention.

In addition, the terms of “section, module, and unit” can be rephrased as “means”, “circuit”, or the like. For example, the acquisition unit can be rephrased as an acquisition means or an acquisition circuit.

What is claimed is:

1. The information processing device comprising:
a specifying unit that specifies search queries of a plurality of users who performs a predetermined action;
a processing unit that generates classification of the search queries and description content of each of a plurality of clusters by inputting, to a model having learned to output a character string following a character string input to the model, information regarding the search queries specified by the specifying unit and a directive, the directive for clustering the search queries into the plurality of clusters in consideration of relevance among search queries and outputting description content describing each of the clusters on a basis of search queries classified into each of the clusters; and
a provision unit that provides information for displaying the plurality of clusters clustered by the model and the description content.

2. The information processing device according to claim 1,
wherein the specifying unit specifies time-series information indicating time series of searches in which the search queries have been used and relevance information indicating relevance of the search queries, with a date and time when the predetermined action has been performed used as a reference date and time, and
the processing unit inputs, to the model, as the directive, the directive instructing to perform clustering in consideration of time series indicated by the time-series information and relevance indicated by the relevance information.

3. The information processing device according to claim 1,
wherein the specifying unit specifies relevance information indicating relevance among the search queries, and
the processing unit inputs, to the model, as the directive, the directive instructing to perform clustering such that a cluster includes search queries belonging to a same purpose of action on a basis of relevance among the search queries indicated by the relevance information.

4. The information processing device according to claim 1,
wherein the specifying unit specifies relevance information indicating relevance among the search queries, and
the processing unit inputs, to the model, as the directive, the directive instructing to perform clustering in consideration of relevance indicated by the relevance information and to perform clustering in consideration of relevance among the clusters that have been classified.

5. The information processing device according to claim 2,
wherein the processing unit further inputs, to the model, as the directive, the directive instructing to output the description content describing each of the clusters on a basis of search queries classified into each of the clusters.

6. The information processing device according to claim 1,
wherein the specifying unit specifies time-series information indicating time series of searches in which the search queries have been used and relevance information indicating relevance of the search queries, with a date and time when the predetermined action has been performed used as a reference date and time, and the processing unit inputs, to the model, as the directive, the directive instructing to perform clustering in consideration of the time series indicated by the time-series information of a period specified by the user and a predetermined period specified by the specifying unit and relevance indicated by the relevance information and, in a case where description content in the period specified by the user and description content in the predetermined period specified by the specifying unit are different from each other in the period specified by the user, instructing to perform at least one of output of an alert or correction.

7. An information processing method executed by a computer, the method comprising:
a specifying step of specifying search queries of a plurality of users who has input a predetermined action;
a processing method of generating classification of the search queries and description content of each of a plurality of clusters by inputting, to a model having learned to output a character string following a character string input to the model, information regarding the search queries specified in the specifying step and a directive, the directive for clustering the search queries into the plurality of clusters in consideration of relevance among search queries and outputting description content describing each of the clusters on a basis of search queries classified into each of the clusters; and
a provision method of providing information for displaying the plurality of clusters clustered by the model and the description content.

8. A non-transitory computer readable storage medium having stored therein an information processing program that causes a computer to execute:
a specifying step of specifying search queries of a plurality of users who has input a predetermined action;
a processing step of generating classification of the search queries and description content of each of a plurality of clusters by inputting, to a model having learned to output a character string following a character string input to the model, information regarding the search queries specified in the specifying step and a directive, the directive for clustering the search queries into the plurality of clusters in consideration of relevance among search queries and outputting description content describing each of the clusters on a basis of search queries classified into each of the clusters; and
a provision step of providing information for displaying the plurality of clusters clustered by the model and the description content.
